(19) United States
(12) Patent Application Publication
(10) Pub. No.: US 2001/0002774 A1
(43) Pub. Date: Jun. 7, 2001

(54) Apparatus and method for powering multiple peripheral devices from a color-coded central power source

(76) Inventor: Noel Lee, Dallas, TX (US)

Correspondence Address: LaRiviere, Grubman & Payne, LLP, P.O. Box 3140, Monterey, CA, 93942, US

(21) Appl. No.: 09/735,697

(22) Filed: Dec. 12, 2000

Related U.S. Application Data
(63) Continuation of application No. 09/221,761, filed on Dec. 28, 1998, now abandoned.
(60) Provisional application No. 60/070,317, filed on Jan. 2, 1998.

(51) Int. Cl. H02B 1/52

(52) U.S. Cl. 307/147

(57) ABSTRACT

An AC power strip with a plurality of power cord receptacles for powering a similar plurality of peripheral devices. In a preferred embodiment the AC power strip includes a housing provided with a plurality of multi-colored AC outlet housing portions each colored a different color to allow allocation of a particular color for a selected peripheral device. Multi-colored stickers and indicia elements are provided to tag power cords of peripheral devices with a selected colored sticker and indicia element. The outlet portions are also provided with an indicia element for identifying the particular peripheral device to be plugged to that AC outlet. Other embodiments include multi-colored sticker and indicia element to modify an existing AC power strip to perform the same objects of the invention. In yet another embodiment, multi-colored extension cords are provided for attaching to a matching colored ac outlet portion.

### RELATED APPLICATION(S)

This application is related to co-pending Provisional Patent Application Ser. No. 60/070,317, entitled: “APPARATUS AND METHOD FOR POWERING MULTIPLE PERIPHERAL DEVICES FROM A CENTRAL POWER SOURCE”, filed Jan. 2, 1998 by the same applicant.

### FIELD OF THE INVENTION

The present invention relates to power distribution apparatus and methods. More particularly, the present invention relates to AC power distribution apparatus and method for powering multiple electrical components that utilize a central power source commonly known as a power strip. Even more particularly, the present invention relates to AC power distribution apparatus and method that provide coding, such as color coding and labeling, to assure correct powering of corresponding remote peripheral electrical devices that are utilizing a common AC power strip.

### BACKGROUND OF THE INVENTION

In home and business applications in which several electrical components, such as personal computer systems, home entertainment centers, and kitchen appliances, (see generally FIG. 1), a conveniently located AC power strip 20 is often provided which is connected to a wall outlet 11 providing AC power from a utility power source 10. The AC power strip 20 (with power cord 21 and plug end 21a), is usually provided with overcurrent and noise protection elements, generally depicted as 22 in FIG. 1, to assure safe and high quality of AC power to a plurality of peripheral devices 30, 40, 50, 60, and 70 attached to the AC power strip 20. As depicted, AC power strip 20 contains a plurality of AC power outlet receptacles 23(a, b, c, d, e, . . . , n) for receiving an AC plug member (35a, 45a, and 55a) provided on the various AC power cords (35, 45, 55, (2) 45x, and 55x). As shown in FIG. 1, the various peripheral devices are not designed with identical means for receiving AC power. By example, a peripheral device 30 may have a fixedly attached power cord 35 with adequate length and type of plug 35a that plugs directly to a mating outlet receptacle 23a on AC power strip 20. Another same device 30 may require an electrical power cord extension 45x because power cord 35 does not have an adequate length. A second device 70, similar to device 30, with power cord 75 and plug 75a may be provided with AC power from a second power cord 45x. Still another device 40 may be provided with only a plug means 41 for receiving power from a power cord 45 with mating receptacle 45b. Yet another device 50 may be provided with a receptacle power inlet means 51 for receiving power from a, perhaps unsafe, power cord 55 having a mating plug 55b. Another device 60 may have a short power cord 65 with receptacle 65a for receiving power from a longer power cord 55x having plug 55b. The attachment cords and the power distribution power strips of the prior art have not been color coded coordinated to achieve connection to the desired peripheral device. The net of the power attachment task has led to confusion as to which device has been plugged to the power strip 20. Thus, a need is seen to exist for a power distribution apparatus and method having a code means for minimizing the confusion associated with powering multiple peripheral electrical device to an AC power strip.

Although prior art, such as U.S. Pat. Nos. 5,589,718 and 5,115,368 and U.S. patent application Ser. No. 08/164,148 have taught the concept of color coding and labeling of AC outlet receptacles, coding of cable terminals with coded geometric structure, coding of power line conditioners and functional cabling for home entertainment systems, such as audio and video system, the problem of ascertaining correct power distribution to peripheral devices is still seen to exist. The prior art has not solved the problem of powering the correct peripheral device by providing a dedicated color coding associated only with AC power distribution from an AC power strip.

Accordingly, it is a primary object of the present invention to provide a color-coded apparatus and method that provides a user a straight-forward way of powering peripheral devices connected to the common power distribution power apparatus source, such as an AC power strip.

Another particular object of the present invention is to provide a indicia-oriented apparatus and method for powering peripheral devices connected to a common power distribution source, such as an AC power strip.

### BRIEF SUMMARY OF THE INVENTION

The foregoing objects are accomplished by providing in one embodiment of the invention, an AC power distribution apparatus comprising a power strip apparatus, a plurality of power cords and a plurality of indicia elements. The power strip apparatus comprises a housing with a plurality of AC outlet portions for providing AC power to the same plurality of peripheral electrical devices. Each AC outlet housing portion being colored with a first color that is different from another AC outlet housing portion. The plurality of power cords comprise a power cord colored to match said first color. The remaining power cords of the plurality of power cords, comprise power cords colored to match each of the other colors on the power strip. The indicia elements are, by example, an adhesive-backing type label having a color that matches the color of the power cord and the corresponding color of the AC outlet housing portion. The indicia elements also comprise identifying information about the peripheral device to be powered.

Another embodiment of the present invention comprises a kit of a plurality of indicia element sets for labeling a respective power strip AC outlet portion, power cord terminals and the peripheral device to which AC power is desired to be distributed. The kit is useful in retrofitting after-market ac power strip product.

The method consists of the steps of providing the color coded power strip, the color coded power cords and color coded indicia elements with identification of the peripheral device and systematically assigning a color to a particular peripheral device to which that particular color is to be associated, and then attaching the color coded power cable to the corresponding AC outlet portion on the AC power strip. Alternatively, the method may be that of providing the kit with indicia elements and assigning a particular color to a peripheral device, then applying the indicia to the power strip AC outlet portion, the power cord terminal ends and to the particular peripheral device.

Therefore, to the accomplishments of the foregoing objects, the invention consists of the foregoing structure and features hereinafter fully described and particularly pointed out in the accompanying drawings and the following disclosure describing in detail the invention, such drawings and disclosure illustrating but one of the various ways in which the invention may be practiced.

### DESCRIPTION OF THE DRAWINGS

FIG. 1 shows a prior art block diagram representation of an AC power distribution arrangement illustrating particular powering configurations that exemplify the problem of matching the correct power cord to a peripheral electrical device.

FIG. 2 shows the same arrangement as depicted in FIG. 1, except that the power strip, power cords and peripheral devices comprise the colored indicia elements of the present invention.

FIG. 3 is a power strip in accordance with the present invention having color coded AC outlet portions provided with color-coded portions either by direct manufacturing, or by applying an appropriate colored label to the AC outlet portion, in accordance with the present invention.

Reference numbers refer to the same or equivalent parts of the present invention throughout the several figures of the drawing.

### DETAILED DESCRIPTION OF THE INVENTION

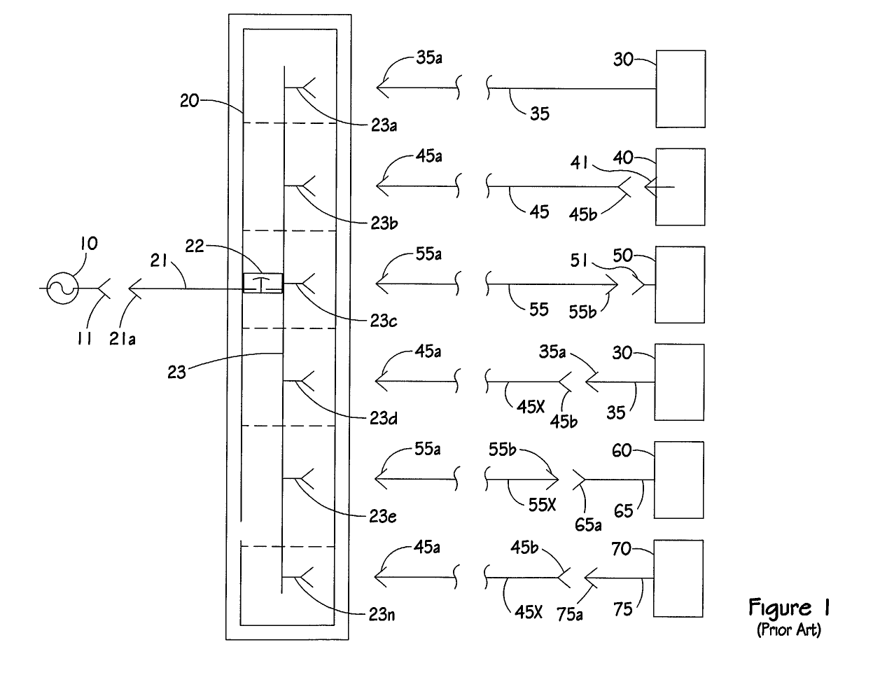

Referring to FIG. 1, where, by example, a home, or business application, comprising peripheral devices 30, 40, 50, 60, and 70 being powered from an AC power strip 20. As depicted, the devices are powered from a conveniently located AC power strip 20 which is connected to a wall outlet 11 providing AC power from a utility power source 10. The AC power strip 20, with power cord 21 and plug end 21a, is usually provided with overcurrent and noise protection elements, generally depicted as 22 in FIG. 1, to assure safe and high quality of AC power to the peripheral devices 30, 40, 50, 60, and 70 attached to the AC power strip 20. Also as depicted, AC power strip 20 contains a main 23 powering a plurality of AC power outlet receptacles 23(a, b, c, d, e . . . , n) for receiving an AC plug member (35a, 45a, and 55a) on the various AC power cords (35, 45, 55, (2) 45x, and 55x). As discussed earlier, while the peripheral devices are not designed with identical means for receiving AC power, the power cords look very similar such that the net of the power attachment task creates confusion as to which device has been plugged to the power strip 20. The confusion is created due to the large variety of powering schemes and power cord devices. As discussed earlier, a peripheral device 30 may have a power cord 35 with adequate length and type of plug 35a that plugs directly to a mating outlet receptacle 23a on AC power strip 20. Another same device 30 may require an electrical power cord extension 45x because power cord 35 does not have an adequate length. A second device 70, similar to device 30, with power cord 75 and plug 75a may be provided with AC power from a second power cord 45x. Still another device 40 may be provided with only a plug means 41 for receiving power from a power cord 45 with mating receptacle 45b. Yet another device 50 may be provided with a receptacle power inlet means 51 for receiving power from a, perhaps unsafe, power cord 55 having a mating plug 55b. Another device 60 may have a short power cord 65 with receptacle 65a for receiving power from a longer power cord 55x having plug 55b.

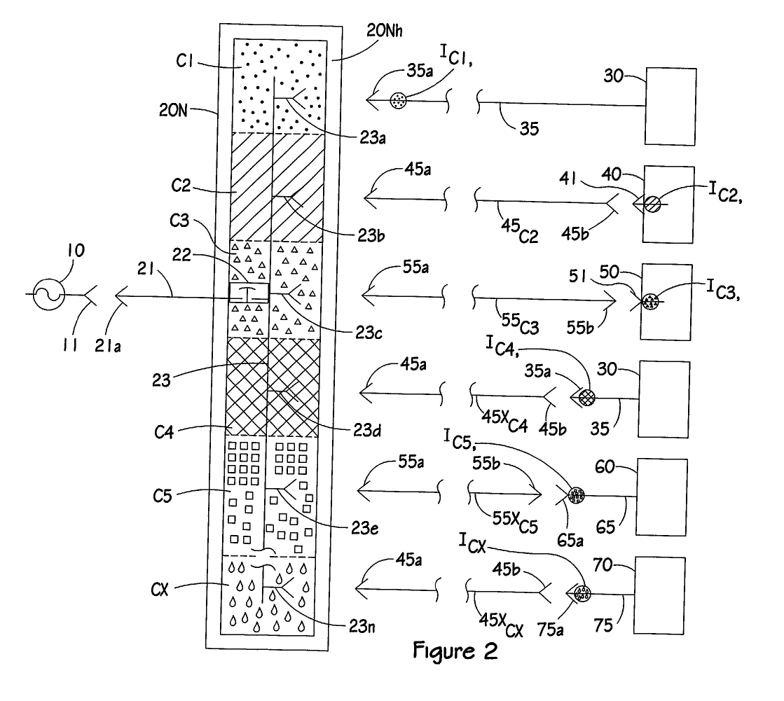

FIG. 2 shows the same arrangement as depicted in FIG. 1, except that the arrangement is provided with a power strip 20N, and a plurality of color coded power cords and colored indicia elements in accordance with the present invention. As depicted, AC power strip 20N now contains a plurality of colored partitions C1, C2, C3, C4, C5 and Cx associated with a corresponding plurality of AC power outlet receptacles 23(a, b, c, d, e, . . . , n). Preferably, a power cord having the same color as a particular colored portion on the power strip is provided. Further, a matching colored indicia element is provided for being placed on a particular peripheral device, or power cord of the device being powered. Each colored partition C1, C2, C3, C4, C5 and Cx comprises indicia that identifies the peripheral that will receive power from the corresponding AC power outlet receptacles 23(a, b, c, d, e, . . . , n). Accordingly, a peripheral device 30 is powered from a power cord 35 with plug 35a having an indicia Ic1 applied to the terminal end. Another device 30 with power cord 35 having an indicia Ic4 applied at, or near its plug end 35a is powered from a colored electrical power cord extension 45xc4. Extension cord 45xc4 is typical of multi-colored cords which may be provided with the kit. The length of the colored extension cords would vary and may, by example be provided in a range from 6 feet to 100 feet. Still referring to FIG. 2, device 70, similar to device 30, with power cord 75, having indicia Icx applied at or near plug 75a, is now powered from AC power strip 20N via power cord 45xcx. Device 40, provided with plug means 41, is now provided with an indicia Ic2 applied proximate plug means 41 and now receives power from a colored power cord 45c2. Device 50 is now provided with plug means 51 having an indicia Ic3 proximately applied, and now receives power from a colored power cord 55c3. Similarly, device 60 is now provided with power cord 65 having plug means 65a having an indicia Ic5 proximately applied, and now receives power from a colored power cord 55xc5.

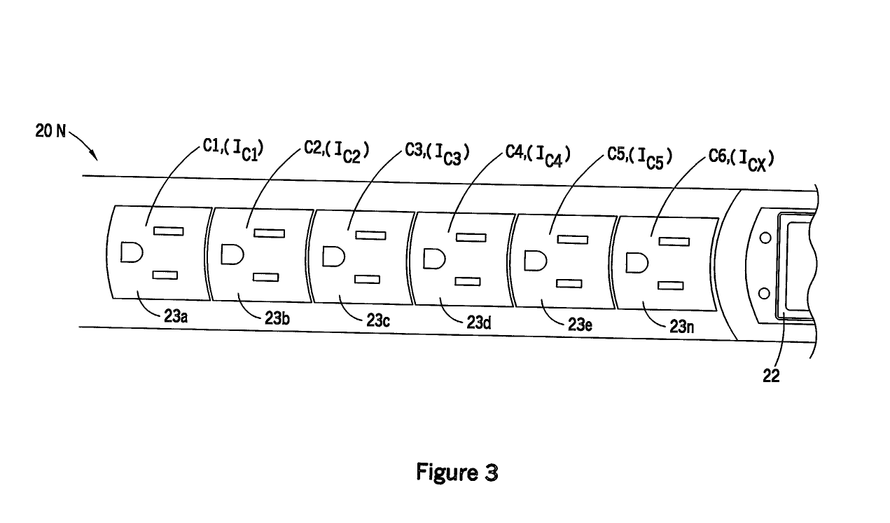

FIG. 3 shows power strip 20N in accordance with the present invention having color coded AC outlet portions C1, C2, C3, C4, C5 and Cx permanently provided at time of manufacturing with the colored portions, or after market, by applying an appropriate colored labels or indicia Icl, Ic2, Ic3, Ic4, Ic5 and Icx to the outlet portions of an AC power strip not provided with permanent color coded portions, in accordance with the present invention. The colored portions C1, C2, C3, C4, C5 and Cx and the colored labels or indicia Ic1, Ic2, Ic3, Ic4, Ic5 and Icx, attachable to the outlet portions of the AC power strip 20N, may include the identifying information of the particular peripheral device to be powered. By example, indicia with the appropriate peripheral device 30, 40, 50, 60, or 70 identity may be imprinted on the indicia.

Modifications may include modifying a particular power cord such that only the terminal housing ends are colored, or a power cord may have the complete cable insulation jacket and power terminal housing colored as well. The power cords may have terminal ends designated as the power source end, or as the device attachment end. If a particular peripheral device's power cord is to plug directly to the AC power strip, then an indicia element having the same color would be applied to the plug end of the device's power cord to match a corresponding same colored portion C1, C2, C3, C4, C5 and Cx, or indicia Ic1, Ic2, Ic3, Ic4, Ic5 and Icx on the power strip with that particular peripheral device identity information on the colored portion or indicia. Similarly, if the peripheral device only has a plug/receptacle power input means, then an indicia element would be applied to the peripheral device for powering from a designated outlet on the power strip.

Therefore, while the present invention has been shown and described herein in what is believed to be the most practical and preferred embodiment, it is recognized that departures can be made therefrom within the scope of the invention, which scope is therefore not to be limited to the details disclosed herein but is to be accorded the full scope of the claims so as to embrace any and all equivalent apparatus.

What is claimed:

1. An AC electrical power strip apparatus, said apparatus comprising:
an input power cord member;
an electrical distribution main electrically coupled to said input power cord member;
a plurality of electrical output receptacle sets electrically coupled to said main, each receptacle set defining an AC electrical outlet circuit surrounded by an outlet body structure;
a housing member, said housing member having inlet means for receiving an end of said input cord and for providing a secured, insulated housing for said receptacle sets, said housing member having a plurality of partitioned access means for facilitating electrical engagement with a respective receptacle set including said outlet body structure surrounding said AC electrical outlet circuit; and
each outlet body structure being colored a different color than other outlet body structures on said AC power strip apparatus.

2. An AC electrical power strip apparatus as described in claim 1, wherein each access means being separated by a partition region having an indicia means for identifying a particular peripheral device to be electrically engaged to a receptacle set via a respective access means.

3. An AC electrical power strip apparatus as described in claim 2, wherein a plurality of multi-colored stickers are provided for selective attachment to an electrical cord providing power to a peripheral device utilizing said power strip apparatus, each sticker being selected such that its color matches a color of the outlet body structure to be utilized for powering a particular peripheral device.

4. An AC electrical power strip apparatus as described in claim 3, wherein said plurality of multi-colored stickers including colored stickers matching a color of said outlet body structure and provided for being attached to said peripheral device being powered from said electrical cord.

5. An AC electrical power strip apparatus as described in claim 1, wherein a plurality of multi-colored electrical extension cords are provided for selective attachment to said power strip apparatus, each attached electrical extension cord being selected such that its color matches a color of the outlet body structure being utilized for powering a particular peripheral device.

6. An AC electrical power strip apparatus as described in claim 5, wherein a plurality of multi-colored stickers are provided for selective attachment to an electrical cord providing power to a peripheral device utilizing said electrical extension cord, each sticker being selected such that its color matches a color of the outlet body structure and the color of an electrical extension cord being utilized.

7. An AC electrical power strip apparatus as described in claim 6, wherein a similarly colored sticker matching a color of said outlet body structure and said electrical extension cord being utilized is provided for being attached to said peripheral device being powered from said electrical extension cord.

8. An AC electrical power strip apparatus, said apparatus comprising:
an input power cord member;
an electrical distribution main electrically coupled to said input power cord member;
a plurality of electrical output receptacle sets electrically coupled to said main, each receptacle set defining an AC electrical outlet circuit surrounded by an outlet body structure;
a housing member, said housing member having inlet means for receiving an end of said input cord and for providing a secured, insulated housing for said receptacle sets, said housing member having a plurality of partitioned access means for facilitating electrical engagement with a respective receptacle set including said outlet body structure of said AC electrical outlet circuit;
wherein each outlet body structure being colored a different color than other outlet body structures on other receptacle sets in said AC electrical outlet circuit; and
wherein each access means being separated by a partition regions having an indicia means for identifying a particular peripheral device to be electrically engaged to a receptacle set via a respective access means.

9. An AC electrical power strip apparatus as described in claim 8, wherein a plurality of multi-colored stickers are provided for selective attachment to an electrical cord providing power to a peripheral device utilizing said power strip apparatus, each sticker being selected such that its color matches a color of the outlet body structure being utilized.

10. An AC electrical power strip apparatus as described in claim 9, wherein a similarly colored sticker matching said outlet body structure being provided for being attached to said peripheral device being powered from said electrical cord.

11. An AC electrical power strip apparatus as described in claim 8, wherein a plurality of multi-colored electrical extension cords are provided for selective attachment to said power strip apparatus, each electrical extension cord being selected such that its color matches a color of the outlet body structure being utilized.

12. An AC electrical power strip apparatus as described in claim 11, wherein a plurality of multi-colored stickers are provided for selective attachment to an electrical cord providing power to a peripheral device utilizing said electrical extension cord, each sticker being selected such that its color matches a color of the outlet body structure and the color of an electrical extension cord being utilized.

13. An AC electrical power strip apparatus as described in claim 12, wherein a similarly colored sticker matching a color of said outlet body structure and said electrical extension cord being provided for being attached to said peripheral device being powered from said electrical extension cord.

14. An AC electrical power strip apparatus, said apparatus comprising:
an input power cord member;
an electrical distribution main electrically coupled to said input power cord member;
a plurality of electrical output receptacle sets electrically coupled to said main, each receptacle set defining an AC electrical outlet circuit surrounded by an outlet body structure;
a housing member, said housing member having inlet means for receiving an end of said input cord and for providing a secured, insulated housing for said receptacle sets, said housing member having a plurality of partitioned access means for facilitating electrical engagement with a respective receptacle set including said body structure of said AC electrical outlet circuit, and
wherein each outlet body structure being provided with a colored sticker means for distinguishing respective AC electrical outlet circuits delineated by said plurality of partitioned access means, each colored sticker means being colored a different color than other colored sticker means provided on other body structures on said AC electrical power strip apparatus.

15. An AC electrical power strip apparatus as described in claim 14, wherein a plurality of multi-colored stickers are provided for selective attachment to an electrical cord providing power to a peripheral device utilizing said power strip apparatus, each sticker being selected such that its color matches a color of the colored sticker means provided on said outlet body structure.

16. An AC electrical power strip apparatus as described in claim 15, wherein a similarly colored sticker matching said colored sticker means provided on said outlet body structure being provided for being attached to said peripheral device being powered from said electrical cord.

17. An AC electrical power strip apparatus as described in claim 14, wherein a plurality of multi-colored electrical extension cords are provided for selective attachment to said power strip apparatus, each electrical extension cord being selected such that its color matches a color of the colored sticker means provided on said outlet body structure being utilized. 18. An AC electrical power strip apparatus as described in claim 17, wherein a plurality of multi-colored stickers are provided for selective attachment to an electrical cord providing power to a peripheral device utilizing said electrical extension cord, each sticker being selected such that its color matches a color of the colored sticker means and the color of an electrical extension cord being utilized.

19. An AC electrical power strip apparatus as described in claim 18, wherein a similarly colored sticker matching a color of said colored sticker means and said electrical extension cord being provided for being attached to said peripheral device being powered from said electrical extension cord.

20. An AC electrical power strip apparatus, said apparatus comprising:
an input power cord member;
an electrical distribution main electrically coupled to said input power cord member;
a plurality of electrical output receptacle sets electrically coupled to said main, each receptacle set defining an AC electrical outlet circuit surrounded by an outlet body structure;
a housing member, said housing member having inlet means for receiving an end of said input cord and for providing a secured, insulated housing for said receptacle sets, said housing member having a plurality of partitioned access means for facilitating electrical engagement with a respective receptacle set including said body structure of said AC electrical outlet circuit; and
each outlet body structure being colored a different color than other outlet body structures on other receptacle sets in said AC electrical outlet circuit,
wherein a plurality of multi-colored stickers are provided for selective attachment to an electrical cord providing power to a peripheral device utilizing said power strip apparatus, each colored sticker being selected such that its color matches a color of the outlet body structure to be utilized for powering a particular peripheral device, and
wherein a similarly colored sticker matching said outlet body structure being provided for being attached to said peripheral device being powered from said electrical cord.

21. An AC electrical power strip apparatus as described in claim 20, wherein each access means being separated by a partition regions having an indicia means for identifying a particular peripheral device to be electrically engaged to a receptacle set via a respective access means.

22. A method of providing AC power to peripheral devices, said method comprising the steps of:
(a) providing an AC power strip;
(b) providing multi-colored AC outlet portions on said AC power strip, each AC outlet portion being colored a different color than other AC outlet portions on said AC power strip;
(c) providing a plurality of multi-colored stickers for use to tag a power cord belonging to a particular peripheral device;
(d) providing an indicia elements on each AC outlet portion with identification information of a peripheral device to be plugged to a particular AC outlet portion;
(e) assigning a color to a particular peripheral device to which that particular color is to be associated;
(f) tagging a power cord with one of said provided multi-stickers, said one sticker having a color according to step (e); and
(g) attaching the tagged color-coded power cord to the corresponding colored AC outlet portion on the AC power strip.

23. An AC electrical power strip apparatus, said apparatus comprising:
an input power cord member;
an electrical distribution main electrically coupled to said input power cord member;
a plurality of electrical output receptacle sets electrically coupled to said main, each receptacle set defining an AC electrical outlet circuit surrounded by an outlet body structure;
a housing member, said housing member having inlet means for receiving an end of said input cord and for providing a secured, insulated housing for said receptacle sets, said housing member having a plurality of partitioned access means for facilitating electrical engagement with a respective receptacle set including said outlet body structure of said AC electrical outlet circuit; and
wherein each access means being separated by a partition regions having an indicia means for identifying a particular peripheral device to be electrically engaged to a receptacle set via a respective access means.

24. An AC electrical power strip apparatus as described in claim 23,
wherein each outlet body structure being colored a different color than other outlet body structures on other receptacle sets in said AC electrical outlet circuit; and
said apparatus further includes a plurality of multi-colored stickers provided for selective attachment to an electrical cord providing power to a peripheral device utilizing said power strip apparatus, each sticker being selected such that its color matches a color of the outlet body structure being utilized.

25. An AC electrical power strip apparatus as described in claim 24, wherein a similarly colored sticker matching said outlet body structure being provided for being attached to said peripheral device being powered from said electrical cord.

26. An AC electrical power strip apparatus as described in claim 24, wherein a plurality of multi-colored electrical extension cords are provided for selective attachment to said power strip apparatus, each electrical extension cord being selected such that its color matches a color of the outlet body structure being utilized.

27. An AC electrical power strip apparatus as described in claim 26, wherein a plurality of multi-colored stickers are provided for selective attachment to an electrical cord providing power to a peripheral device utilizing said electrical extension cord, each sticker being selected such that its color matches a color of the outlet body structure and the color of an electrical extension cord being utilized.

28. An AC electrical power strip apparatus as described in claim 27, wherein a similarly colored sticker matching a color of said outlet body structure and said electrical extension cord being provided for being attached to said peripheral device being powered from said electrical extension cord.
